(19) United States
(12) Patent Application Publication
(10) Pub. No.: US 2015/0120862 A1
(43) Pub. Date: Apr. 30, 2015

(54) DATA RECOVERY

(71) Applicant: Hans Erickson, Grosse Pointe Park, MI (US)

(72) Inventor: Hans Erickson, Grosse Pointe Park, MI (US)

(21) Appl. No.: 14/525,067

(22) Filed: Oct. 27, 2014

Related U.S. Application Data
(60) Provisional application No. 61/895,660, filed on Oct. 25, 2013.

(51) Int. Cl. G06F 11/14; H04L 29/08

(52) U.S. Cl. CPC G06F 11/1412; H04L 67/1097; G06F 11/1435; G06F 11/1441
USPC 709/216; 714/6.11

(57) ABSTRACT

A data recovery software program and delivery system is provided that is designed to operate independently of an installed host computer operating system for extracting information from memory storage devices and hard drives of the host computer, and overwriting the information on the host computer, once the information has been extracted from the host computer, so that no others can retrieve the information from the host computer. The data recovery software allows a user to restart a computer that is still mechanically operative, but has experienced an operating system failure. The data recovery software is able to gain control of a host computer even when there are failed sectors on the hard drive of the host computer. The data recovery software system can be loaded universal serial bus (USB) flash drives, compact discs, digital versatile discs, or other external storage devices that are USB or firewire IEEE 1394 interface enabled.

### RELATED APPLICATIONS

This application claims priority benefit of U.S. Provisional Application Ser. No. 61/895,660 filed Oct. 25, 2013; the contents of which are hereby incorporated by reference.

### FIELD OF THE INVENTION

The present invention in general relates to data recovery, and in particular to a data recovery software program and delivery system designed to operate independent of an installed host computer operating system.

### BACKGROUND OF THE INVENTION

Data Recovery is the process of salvaging data from damaged, failed, corrupted, or inaccessible secondary storage media when it cannot be accessed normally. Secondary storage (also known as external memory or auxiliary storage), differs from primary storage (i.e., random access memory (RAM)) in that it is not directly accessible by the central processing unit (CPU). The computer usually uses its input/output channels to access secondary storage and transfers the desired data using an intermediate area in primary storage. Secondary storage is non-volatile, which means it does not lose the data when the device is powered down. Hard disk drives and solid state drives are usually used as secondary storage for desktop computers. The most common scenario that requires data recovery involves an operating system (OS) failure in which the goal is simply to copy all wanted files to another storage media or device.

Many computer users are familiar with the basic operations of their systems; however tasks such as data recovery are often daunting to them.

Thus, there exists a need for recovery software program and delivery system designed to operate independent of an installed host computer operating system that is easy to use with a minimum of required user instruction and user intervention.

### SUMMARY OF THE INVENTION

A data recovery system is provided that includes a delivery device holding a software program to be loaded into a host computer, the software program configured to load automatically and to operate independent of an installed operating system of the host computer, the software program having instructions for controlling a processor for the extraction of information from one or more memory storage devices and hard drives of the host computer, and for the transfer of the extracted information to an external storage device; and wherein data and file content transferred during the extraction of information is determined by a set of icons manipulated by a user, where the set of icons represent the one or more memory storage devices and hard drives of said host computer.

A machine-readable medium storing thereon one or more instructions, which when implemented causes a processor to implement a method for data recovery from a host computer, the method includes: receiving a set of basic input/output system (BIOS) settings for a boot device of the host computer to recognize the machine-readable medium during powering on of the host computer; extracting a set of information from one or more memory storage devices and hard drives of the host computer; transferring the extracted set of information to an external storage device; wherein the one or more instructions are carried out independently of an installed operating system of the host computer; and wherein data and file content transferred during the extraction of the set information is determined by a set of icons manipulated by a user, where the set of icons represent the one or more memory storage devices and hard drives of the host computer.

A method for data recovery from a host computer, the method includes: inserting a delivery device into a host computer, the delivery device holding a software program configured to load automatically and to operate independently of an installed operating system of the host computer by changing a set of basic input/output system (BIOS) settings for a boot device of the host computer to recognize the delivery device during powering on of the host computer; wherein the software program further comprises instructions for controlling a processor for the extraction of information from one or more memory storage devices and hard drives of the host computer, and for the transfer of the extracted information to an external storage device; and wherein data and file content transferred during the extraction of information is determined by a set of icons manipulated by a user with a graphical user interface (GUI) generated by the software program, where the set of icons represent the one or more memory storage devices and hard drives of the host computer.

### BRIEF DESCRIPTION OF THE DRAWINGS

The present invention is further detailed with respect to the following drawings that are intended to show certain aspects of the present invention, but should not be construed as a limit on the practice of the present invention.

FIG. 1 illustrates a flowchart of a method for creating the software platform according to embodiments of the invention;

FIG. 2 illustrates a flowchart of a method for using the software platform according to embodiments of the invention;

FIG. 3 illustrates a screenshot of the graphical user interface according to embodiments of the invention;

FIG. 4 illustrates a USB thumb drive or flash drive for implementing the inventive software according to embodiments of the invention; and

FIG. 5 is a schematic diagram illustrating an overall view of communication devices, computing devices, and mediums for implementing embodiments of the invention.

### DESCRIPTION OF THE INVENTION

The present invention has utility as a data recovery software program and delivery system designed to operate independent of an installed host computer operating system for extracting information from the memory storage devices and hard drives of the host computer, and overwriting the information on the host computer, once the information has been extracted from the host computer, so that no others can retrieve the information from the host computer. Embodiments of the inventive data recovery software system allow a user to restart a computer that is still mechanically operative, but has experienced an operating system failure. Furthermore, the inventive data recovery software is able to gain control of a host computer even when there are failed sectors on the hard drive of the host computer.

Embodiments of the inventive data recovery software system can be loaded into the host computer memory from delivery devices such as a universal serial bus (USB) flash drive, compact disc (CD), digital versatile disc (DVD), or other external storage devices that are USB or firewire IEEE 1394 interface enabled. The loading of the inventive software is transparent to the user, and when the installed inventive software is in use, operations for source and destination file decisions are simplified for the user via a graphical user interface (GUI) provided for extracting the data via drag and drop commands. Following the loading of embodiments of the inventive software on to the host computer, external storage devices can then be attached to the host computer running the inventive software that have the storage capacity to hold the information being removed from the host computer. In certain embodiments, the inventive software may be preloaded in a storage device with adequate storage space to accept the extracted data, so as to eliminate the need for the user to make additional connections to their host computer besides the initial connection to load the inventive extraction software. For example, a high capacity USB flash drive with a small form factor may contain the inventive software, as well as provide storage space for the extracted data. In certain embodiments where a network connection to the Internet is available to the host computer, a user may choose to transfer their data to a secure shared remote server for later retrieval, such as a cloud based storage solution.

While embodiments of the inventive data extraction software tool provide sophisticated capabilities for the end user, the operations are carried out with a simple and easy to understand user interface that does not require additional instructions, other than to adjust the host computer basic input/output system (BIOS) settings for a boot device, if necessary. The fundamental purposes of the BIOS are to initialize and test the system hardware components, and to load a bootloader or an operating system from a mass memory device. The BIOS may access a master boot record (MBR) which is a special type of boot sector at the very beginning of partitioned computer mass storage devices. The MBR holds the information on how the logical partitions, containing file systems, are organized on that mass storage device. Besides the information on logical partitions, the MBR contains executable code to function as an operating system-independent chain boot loader in conjunction with each partition's volume boot record (VBR). The BIOS software is built into the PC hardware as firmware, and is the first software run by a PC when powered on. The BIOS controls the ‘boot order’, or where the host computer looks first for an operating system. All computers have the ability to load an operating system into memory from several locations including the hard drive, CD/DVD and USB are other popular options, as well as directly from a network connection. When a computer is powered on, the BIOS checks possible locations for an operating system to load. The first operating system (OS) that the BIOS finds will be loaded into the computer memory, and then the BIOS transfers control to the OS. Because most PC's are set to look at the CD/DVD and USB ports before looking at the hard drive, the inventive software will be seen before the existing OS and the computer will load the inventive software into memory and transfer control to an embodiment of the inventive software. Embodiments of the inventive software can then access all of the user's files on a host computer without experiencing any of the troubles the normal operating system is having. The BIOS adjustment may be required if the host computer fails to automatically recognize the device holding the inventive extraction software as the boot device or medium.

In the event a host computer that is targeted for data recovery with embodiments of the inventive software is infected with viruses, trojans, rootkit, and/or malware, these infections do not pose a problem since the inventive software does not transfer executable files or programs with the recovered data. Most malware/viruses attach themselves to programs or executable codes that are run in memory so that they can take control of the infected computer.

Embodiments of the inventive recovery software are based on various versions of Linux software. In certain embodiments a version of Linux referred to as Slacko Puppy is used. Puppy Linux is a lightweight Linux distribution that focuses on ease of use. The Slacko series has high Slackware binary software packages compatibility (hence is a Spup), and the entire target computer system can be run from RAM, allowing the boot medium (USB drive, CD, DVD, etc.) to be removed after the operating system has started.

Embodiments of the inventive data recovery software are formed from a full version of Linux, which is then masked to remove all components that are not necessary to find and move data. Software to over write the data is added, as it does not exist in versions of Linux such as in Slacko 3.5.5. Furthermore, to provide a higher level of operating transparency to the user all questions and pauses that occur during a typical Linux installation are answered for the user and the pauses are removed. Boot options offered for various technical situations are removed. Internet connectivity is made automatically in the background in case remote support is needed later, and/or remote networked storage for the extracted data is to be used. The modifications to the Linux code are made to simplify use and provide the widest possible compatibility with end user computing devices.

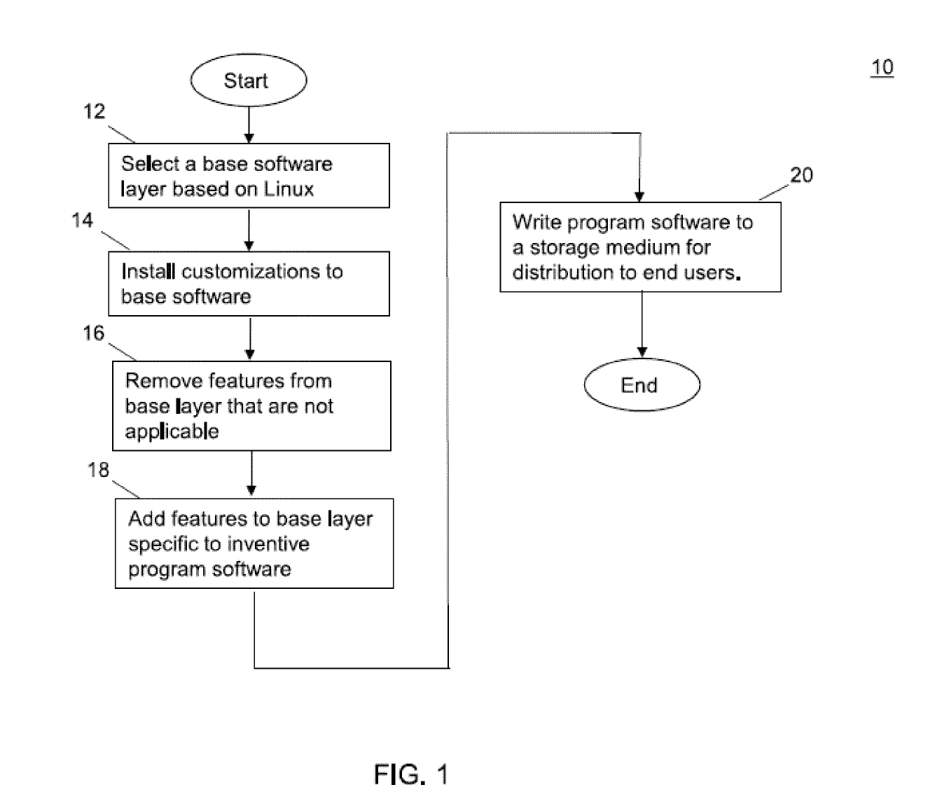

Referring now to the figures, FIG. 1 illustrates a high level summary of a process 10 for creating the inventive data recovery software and delivery platform. The process starts by selecting a base software layer (step 12) that may be based on a version of Linux such as puppy slacko 3.5.5 or any other version of Linux. At step 14, customizations to the software are installed including auto screen resolution for the user display device, keyboard, network information for automatically contacting remote support and optional remote network storage, and save drive. Features that are not needed in the base layer are removed (step 16) including multiple desktops, application icons, and application menus. Features that are needed to carry out the data recovery are added to the base layer (step 18) including custom drive icons that indicate storage locations on a host computer targeted for data extraction, letter drive references (as found in Window OS), automatic mounting and unmounting of drives, hide inventive recovery software partition (i.e., hide partition where recovery software stored), system menu, help screen with step by step instructions, wipe drive software for overwriting and deleting files on the host computer, and desktop instructions. At step 20 the inventive data recovery software is written or saved on a storage medium for distribution to end users, where the storage mediums include USB flash drives, external hard drives, CD, and DVD, etc.

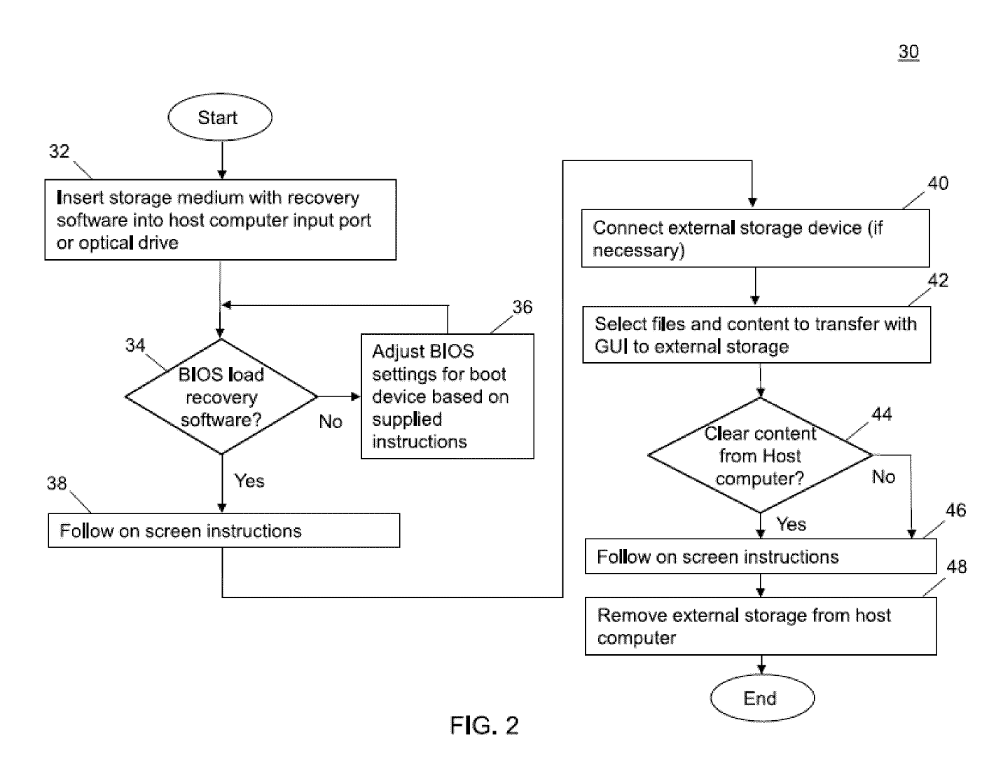

FIG. 2 illustrates a process 30 of implementation of the inventive recovery software according to an embodiment of the invention. An end user inserts the storage medium (USB flash drive, CD, DVD, hard drive, etc.) with the inventive recovery software into the host computer input port or optical drive (step 32) which when the host computer is powered on should load the inventive software as the operating system if at step 34 the BIOS recognizes the input port or optical drive engaged with the storage medium as the boot device. If the BIOS does not recognize the engaged input port or optical drive, an adjustment to the host computer BIOS settings for the boot device is required based on the supplied instructions (step 36). If the BIOS recognizes the input port or optical drive engaged with the storage medium as the boot device (step 34 is Yes) a series of on screen instructions are presented to the user to follow (step 38) to connect an external storage device for accepting and storing the extracted data from the host computer, if the medium with the recovery software lacks the storage capacity to hold the extracted data (step 40). The user selects files and content to transfer from the host computer with the graphical user interface (GUI) of embodiments of the recovery software (step 42). In an embodiment the transferred data and content is automatically cleared from host computer storage, or the user is prompted to decide (step 44) whether to clear or keep the data on the host computer, and based on the decision follows on screen instructions for completing the data recovery process (step 46), and the user removes the external storage from the host computer (step 48).

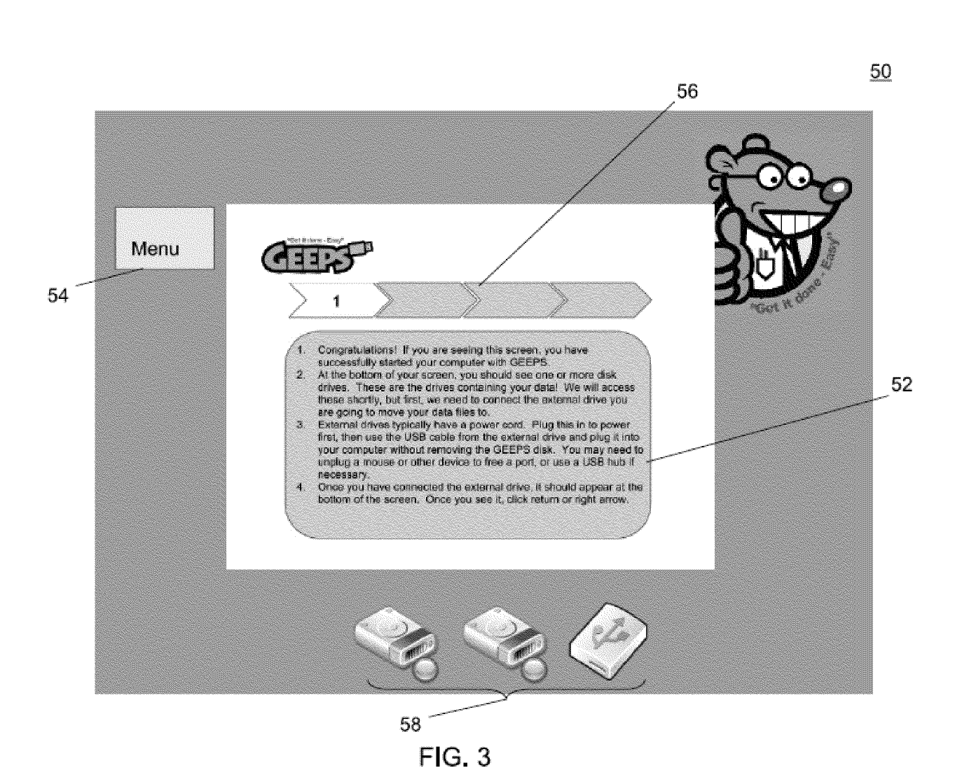

FIG. 3 is a screenshot 50 of the GUI of the inventive recovery software with on screen instructions 52, a menu selection button 54, a process progress indicator 56, and icons 58 representing storage devices on the host computer. The icons 58 may be used by a user to graphically drag and drop files and information from storage devices and locations on the host computer to the transfer storage device.

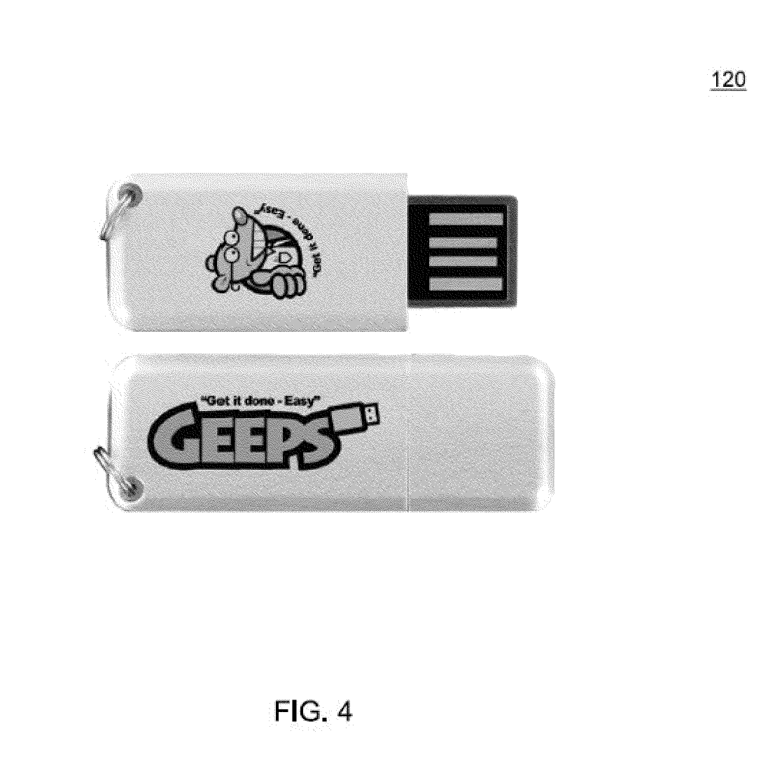

FIG. 4 illustrates an embodiment of the inventive data recovery system as a USB flash or thumb drive 120. An end user plugs the thumb drive 120 into a target host computer for recovering the data. In certain embodiments, a thumb drive with additional available storage capacity, besides the stored inventive recovery software program, may also be used for storing the recovered data from the host computer.

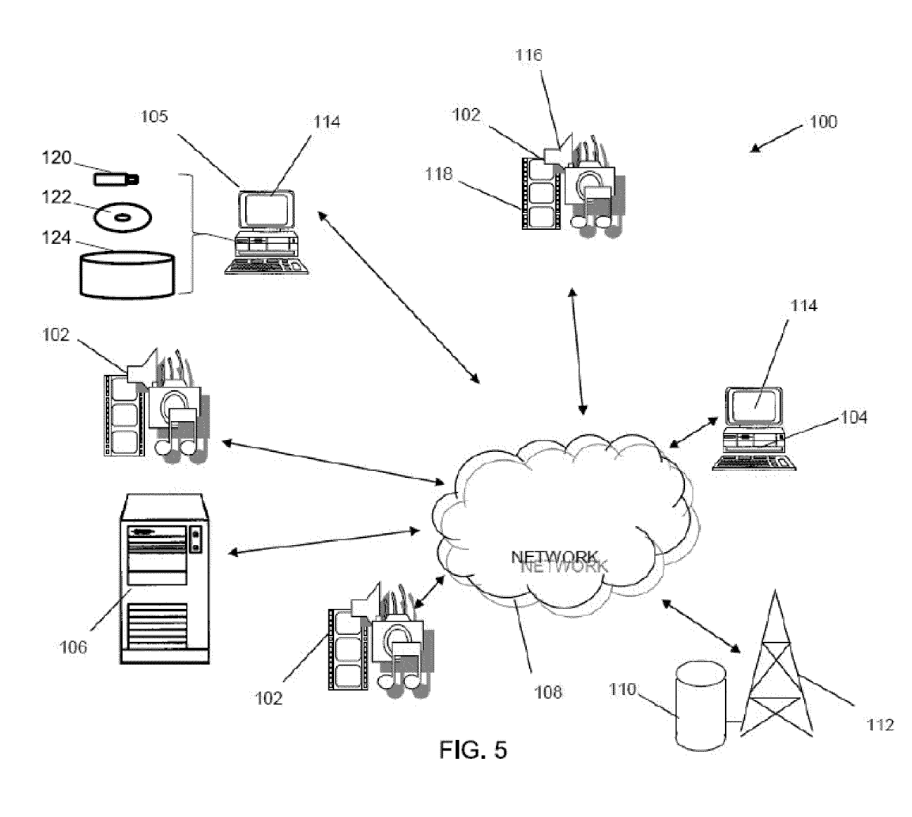

FIG. 5 is a schematic diagram illustrating an overall view of communication devices, computing devices, and mediums for implementing the software recovery platform according to embodiments of the invention. The elements of the embodiments of FIGS. 1-4 are included in the networks and devices of FIG. 5.

The system 100 includes multimedia devices 102 and desktop computer devices 104 configured with display capabilities 114 and processors for executing instructions and commands. The multimedia devices 102 are optionally mobile communication and entertainment devices, such as cellular phones and mobile computing devices that in certain embodiments are wirelessly connected to a network 108. The multimedia devices 102 typically have video displays 118 and audio outputs 116. The multimedia devices 102 and desktop computer devices 104 are optionally configured with internal storage, software, and a graphical user interface (GUI) for carrying out elements of the platform according to embodiments of the invention. The network 108 is optionally any type of known network including a fixed wire line network, cable and fiber optics, over the air broadcasts, satellite 120, local area network (LAN), wide area network (WAN), global network (e.g., Internet), intranet, etc. with data/Internet and remote storage capabilities as represented by server 106. Communication aspects of the network are represented by cellular base station 110 and antenna 112. In a preferred embodiment, the network 108 is a LAN and each remote device 102 and desktop device 104 executes a user interface application (e.g., Web browser) to contact the server system 106 through the network 108. Alternatively, the remote devices 102 and 104 may be implemented using a device programmed primarily for accessing network 108 such as a remote client. The network 108 may be accessed by the user during a recovery operation to reach online help.

The software for the platform, of embodiments of the invention, may be resident on a USB thumb or flash drive 120, CD or DVD 122, or an external hard drive 124 for connection to desktop or laptop computers 104, or stored within the server 106 or cellular base station 110 for download to an end user. Server 106 may implement a cloud-based service for implementing embodiments of the platform with a multi-tenant database for storage of separate client data that may be transferred during a recovery operation from a computer or laptop 104.

The foregoing description is illustrative of particular embodiments of the invention, but is not meant to be a limitation upon the practice thereof. The following claims, including all equivalents thereof, are intended to define the scope of the invention.

1. A data recovery system, said system comprising:
a delivery device holding a software program to be loaded into a host computer, said software program configured to load automatically and to operate independent of an installed operating system of said host computer, said software program comprising instructions for controlling a processor for the extraction of information from one or more memory storage devices and hard drives of said host computer, and for the transfer of the extracted information to an external storage device; and
wherein data and file content transferred during the extraction of information is determined by a set of icons manipulated by a user, where said set of icons represent said one or more memory storage devices and hard drives of said host computer.

2. The system of claim 1 wherein said software program further comprises a graphical user interface (GUI).

3. The system of claim 1 further comprising instructions for changing a set of basic input/output system (BIOS) settings for a boot device of said host computer to recognize said delivery device during powering on of said host computer.

4. The system of claim 1 wherein said delivery device is a compact disc (CD) or digital versatile disc (DVD).

5. The system of claim 1 wherein said delivery device is a universal serial bus (USB) or a firewire IEEE 1394 interface enabled compatible device.

6. The system of claim 5 wherein said USB compatible device is a flash drive.

7. The system of claim 5 wherein said USB compatible device is an external hard drive.

8. The system of claim 5 wherein said USB compatible device also serves as said external storage device for said transferred data

9. The system of claim 1 wherein said transferred data is cleared from said host computer.

10. The system of claim 1 wherein said transferred data is cleared from said host computer based on said user's response to a prompt generated by said software program.

11. The system of claim 1 wherein said software program is Linux based.

12. The system of claim 1 wherein said software program is based on a Slacko puppy version of Linux that is customized.

13. The system of claim 1 wherein said transferred data is stored on a remote networked server.

14. The system of claim 13 wherein said remote network server is a cloud based storage solution.

15. A machine-readable medium storing thereon one or more instructions, which when implemented cause a processor to implement a method for data recovery from a host computer, the method comprising:
receiving a set of basic input/output system (BIOS) settings for a boot device of said host computer to recognize said machine-readable medium during powering on of said host computer;
extracting a set of information from one or more memory storage devices and hard drives of said host computer;
transferring the extracted set of information to an external storage device;
wherein the one or more instructions are carried out independently of an installed operating system of said host computer; and
wherein data and file content transferred during the extraction of the set information is determined by a set of icons manipulated by a user, where said set of icons represent said one or more memory storage devices and hard drives of said host computer.

16. The machine-readable medium of claim 15 wherein said medium is a compact disc (CD), digital versatile disc (DVD), a universal serial bus (USB), or a firewire IEEE 1394 interface enabled compatible device.

17. The machine-readable medium of claim 16 wherein said USB compatible device comprises one of a flash drive, or an external hard drive.

18. A method for data recovery from a host computer, the method comprising:
inserting a delivery device into a host computer, said delivery device holding a software program configured to load automatically and to operate independently of an installed operating system of said host computer by changing a set of basic input/output system (BIOS) settings for a boot device of said host computer to recognize said delivery device during powering on of said host computer;
wherein said software program further comprises instructions for controlling a processor for the extraction of information from one or more memory storage devices and hard drives of said host computer, and for the transfer of the extracted information to an external storage device; and
wherein data and file content transferred during the extraction of information is determined by a set of icons manipulated by a user with a graphical user interface (GUI) generated by said software program, where said set of icons represent said one or more memory storage devices and hard drives of said host computer.

19. The method of claim 18 wherein said delivery device is a compact disc (CD), digital versatile disc (DVD), a universal serial bus (USB), or a firewire IEEE 1394 interface enabled compatible device.

20. The method of claim 19 wherein said universal serial bus (USB) compatible device comprises one of a flash drive, or an external hard drive.
